(19) United States
(12) Patent Application Publication
(10) Pub. No.: US 2012/0033538 A1
(43) Pub. Date: Feb. 9, 2012

(54) STORAGE APPARATUS

(75) Inventor: Tsuyoshi Ozeki, Nagoya-shi (JP)

(73) Assignee: BUFFALO INC., Nagoya-shi (JP)

(21) Appl. No.: 13/195,865

(22) Filed: Aug. 2, 2011

(30) Foreign Application Priority Data
Aug. 3, 2010 (JP) 2010-174373

(51) Int. Cl. G11B 33/02

(52) U.S. Cl. 369/75.11; G9B/33.005

(57) ABSTRACT

A storage apparatus comprising: a casing forming a housing chamber; a disk drive housed in, at a spacing from, the housing chamber, such that unit outer walls of the disk drive are separated by a clearance from inner walls of the casing; and a buffer member interposed in the clearance between the disk drive and the casing, for absorbing an impact stress. The buffer member is formed of a material having flexibility, and is provided with: a support part fitted to a wall surface of one of either the disk drive or the casing; a hemispherically shaped dome part, formed on the support part; and an abutment part, formed along a top portion of the dome part, abutting on a wall surface of the other of either the disk drive or the casing. The dome part and the support part form, together with the wall surface of the one of either the disk drive or the casing, a sealing chamber sealing in air, whereby the dome part is lent elasticity.

### CROSS REFERENCE TO RELATED APPLICATION

The disclosure of Japanese Patent Application No. 2010-174373, filed on Aug. 3, 2010, is incorporated herein by reference.

### BACKGROUND OF THE INVENTION

1. Field of the Invention

The present invention relates to storage apparatuses furnished with buffer members for protecting the disk drive from external shock.

2. Description of the Background Art

Among storage apparatuses to date, known examples of hard disk drive apparatuses include the hard disk drives that Japanese Laid-Open Patent Publication No. 2003-272367 and Japanese Laid-Open Patent Publication No. 2004-55013, for example, disclose. These hard disk drive apparatuses are furnished with a hard-disk drive unit housed inside a casing, and buffer members, interposed between the hard-disk drive unit and the inner walls of the casing, that by undergoing distortion on receiving stressing force absorb shocks/stresses. The buffer members absorb shock during a fall or the like, cushioning the hard disk drive apparatuses from the shock of the impact. Chips of sheet rubber are generally used as such buffer members, and cushion the impact of a shock by absorbing the energy through their elastic compression.

However, an issue with conventional buffer members has been that if the maximum amount that they compress is exceeded due to an external impact, the impact force abruptly increases. In addition, buffer members of a thickness corresponding to the clearance in between the inner wall of the casing and the hard-disk drive unit must be employed, and consequently in situations where the dimension tolerance is large, or in situations where it is desired to adapt the buffer members to hard-disk drive units having different outer dimensions, the thickness of the buffer members must be varied accordingly. The buffer members have thus lacked general versatility. In addition, in situations where the clearance between the inner wall of the casing and the hard-disk drive is large, the buffer material quantity increases, resulting in increase in cost.

### SUMMARY OF THE INVENTION

An object of the present invention is to provide, at low cost, a storage apparatus that has excellent shock resistance even if disk drive units to be housed have a large dimension tolerance or are different in their outer dimensions, so that the above problems will be solved.

### SOLUTION TO THE PROBLEMS

The present invention has been made to solve at least a part of the above problems, and can be realized as the following aspects or application examples.

A storage apparatus according to the present invention comprises: a casing forming a housing chamber; a disk drive housed in, at a spacing from, the housing chamber, such that unit outer walls of the disk drive are separated by a clearance from inner walls of the casing; and a buffer member interposed in the clearance between the disk drive and the casing, for absorbing an impact stress. The buffer member is formed of a material having flexibility, and is provided with: a support part fitted to a wall surface of one of either the disk drive or the casing; a hemispherically shaped dome part, formed on the support part, and; an abutment part, formed along a top portion of the dome part, abutting on a wall surface of the other of either the disk drive or the casing. The dome part and the support part form, together with the wall surface of the one of either the disk drive or the casing, a sealing chamber sealing in air, whereby the dome part is lent elasticity.

Preferably, the storage apparatus may further comprise an adhesive sheet, fastened to the support part, for enhancing airtightness of the sealing chamber.

Preferably, in the storage apparatus, against a direction in which the dome part flexes, the abutment part is of stiffness that is greater than that of the dome part.

Preferably, in the storage apparatus, the support part on a peripheral portion thereof includes a projecting rail.

Preferably, in the storage apparatus, at least one sub-dome part whose height is lower than that of the dome part is formed on a peripheral portion of the support part that is along an outer side of the dome part; and the at least one sub-dome part forms, with the wall surface of the one of either the disk drive or the casing, a sealing chamber for sealing in air, whereby the at least one sub-dome part is lent elasticity.

According to the present invention, even if disk drive units to be housed have a large dimension tolerance or are different in their outer dimensions, a storage apparatus having an excellent impact resistance can be provided with a low cost.

The present invention can be used for storage apparatuses and the like, and particularly, is useful for improving the impact resistance of storage apparatuses. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view showing the configuration of a hard disk drive apparatus according to an embodiment of the present invention;

FIG. 2 is a perspective view of the buffer member according to the embodiment of the present invention;

FIG. 3 is a cross-sectional view of the buffer member according to the embodiment of the present invention;

FIG. 4 is a cross-sectional view for explaining the effect of the buffer member according to the embodiment of the present invention;

FIG. 5 is a cross-sectional view for explaining the effect of the buffer member according to the embodiment of the present invention;

FIG. 6 is a perspective view of a buffer member according to a modification of the present invention;

FIG. 7 is a perspective view of a buffer member according to another modification of the present invention; and

FIG. 8 is a perspective view of a buffer member according to another modification of the present invention.

### DESCRIPTION OF THE PREFERRED EMBODIMENTS

Hereinafter, embodiments of the present invention will be described.

(The Schematic Configuration of a Hard Disk Drive Apparatus 10)

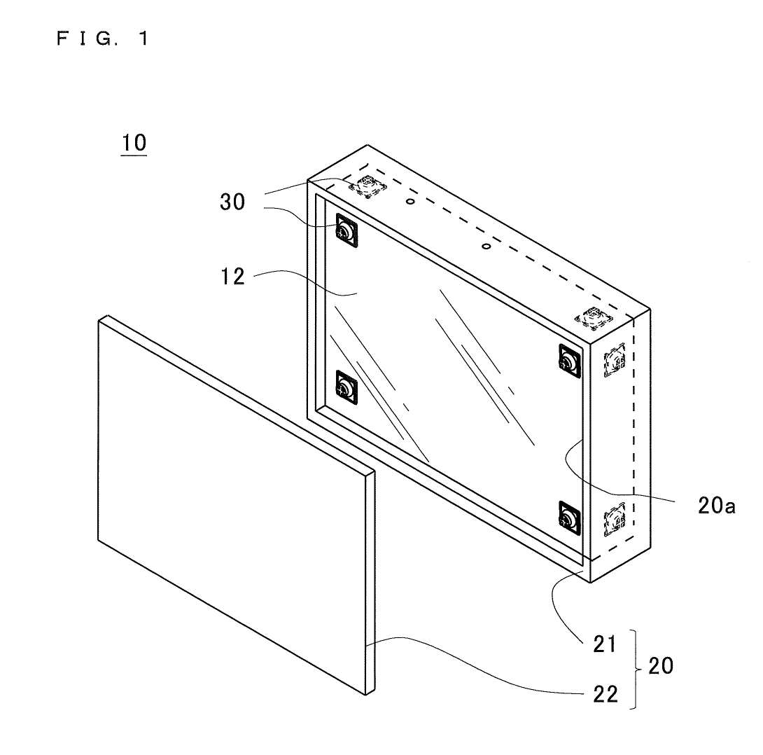

FIG. 1 is an exploded perspective view of a hard disk drive apparatus 10 (storage apparatus) according to the present embodiment. The hard disk drive apparatus 10 includes a hard-disk drive unit 12 (disk drive), a casing 20 for housing the hard-disk drive unit 12, buffer members 30 provided between the hard-disk drive unit 12 and the inner wall of the casing 20, and is connectable to a computer via a USB cable.

The hard-disk drive unit 12 is a general-purpose hard disk drive of 3.5-inch type housed in a unit case made of metal. The casing 20 is a housing made of a plastic resin, and forms a housing chamber 20a. The casing 20 includes a casing main body 21 and a lid body 22. The casing main body 21 and the lid body 22 are integrated by an engagement mechanism such as a nail. In addition to a positioning protrusion, the buffer members 30 are attached to the inner walls of the casing main body 21 and the lid body 22. The buffer members 30 are elastic members which are positioned between the wall surfaces of the casing 20 and the hard-disk drive unit 12 when the hard-disk drive unit 12 is set in the casing 20, thereby providing an impact resistance. The buffer members 30 are arranged at the corners of the outer walls of the hard-disk drive unit 12.

(Configuration of Buffer Member 30)

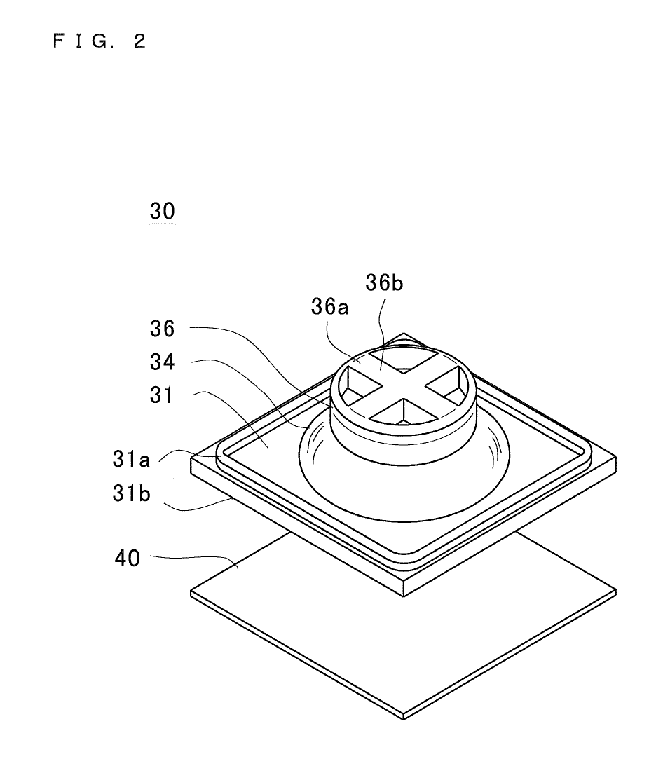

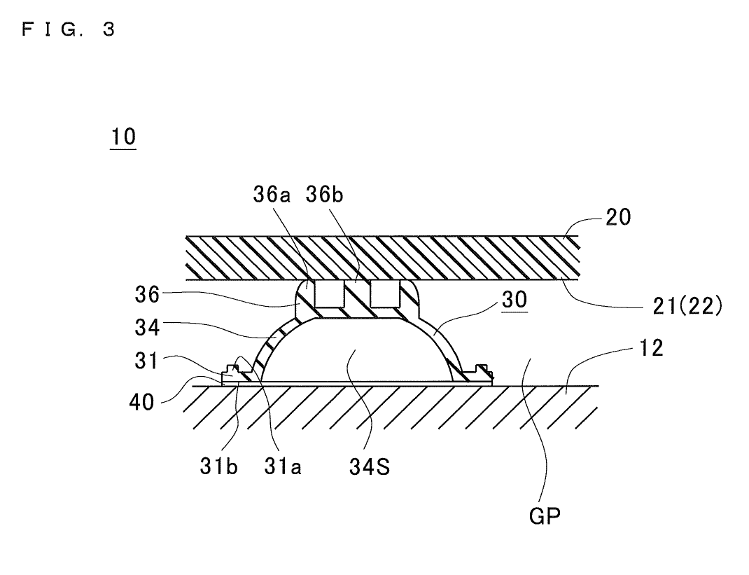

FIG. 2 is a perspective view of the buffer member 30 of the present embodiment, and FIG. 3 is an enlarged cross-sectional view showing the buffer member 30 attached in a clearance GP between the hard-disk drive unit 12 and the inner wall of the casing 20. The buffer member 30 includes: a supporting section 31 attached to the hard-disk drive unit 12 via an adhesive sheet 40; a dome section 34 formed on the supporting section 31; and an abutment part 36, formed on the dome section 34, that is in contact with the casing main body 21 or the lid body 22 which forms the casing 20. These components are formed in an integrated manner.

The supporting section 31 is a section for attaching the buffer member 30 to the hard-disk drive unit 12, and its appearance is squared-shaped. A projecting rail 31a is formed at a peripheral portion of the supporting section 31, and mechanically reinforces the peripheral portion of the supporting section 31. The dome section 34 has a thin body, an almost hemispherical shape, and a flexibility. The abutment part 36 includes a tube section 36a protruding from the top portion of the dome section 34, and a bridge section 36b bridging the tube section 36a and having a cross shape that crosses at the center of the tube section 36a. The other part, of the abutment part 36, than the tube section 36a and the bridge section 36b is hollowed. The end surfaces of the tube section 36a and the bridge section 36b are included in an identical plane, and are configured such that the end surfaces are both in contact with and almost perpendicular to the casing main body 21 or the lid body 22 which forms the casing 20. The inner space surrounded by the dome section 34 and the abutment part 36 forms a sealing chamber 34S. The stiffness of the abutment part 36 in the direction in which the dome section 34 flexes is larger than that of the dome section 34. As a result, a displacement occurring in the casing 20 when the casing 20 has received an impact is conducted to the dome section 34 via the abutment part 36. At this time, since the sealing chamber S34 is compressed, the dome section 34 has elasticity, thereby making an impact absorbability. That is, when the buffer member 30 has received an impact stress, the abutment part 36 almost keeps its shape, and mainly the dome section 34 is subjected to elastic deformation.

The adhesive sheet 40 is formed by a so-called double-faced tape, an adhesive agent being applied to its both surfaces. One of the adhesive surfaces of the adhesive sheet 40 is adhered to the supporting surface 31b of the supporting section 31, thereby enhancing the airtightness of the sealing chamber 34S. In addition, the other one of the adhesive surfaces of the adhesive sheet 40 is adhered to the wall surface of the hard-disk drive unit 12, whereby the buffer member 30 is attached to the wall surface of the hard-disk drive unit 12.

Here, a flexible material such as silicon rubber, polyurethane, silicon gel, or an elastomer may be used as a material of the buffer member 30. In addition, in light of the property of the materials, the impact resistance, and the like described above, the thickness of the buffer member 30 may be 0.3 to 0.6 mm at the supporting section 31, 0.3 to 0.6 mm at the dome section 34, and 0.5 to 1.0 mm at the tube section 36a and the bridge section 36b of the abutment part 36. In addition, the height of the buffer member 30 may be set at 2 to 5 mm. The buffer members 30 configured as described above may be created, for example, through the process that a plurality of models in a matrix state are formed at the same time by using unvulcanized rubber, the resultant members are vulcanized, sheets as the adhesive sheets 40 are attached thereto, and then the resultant members are cut into individual pieces.

(Effects)

The buffer members 30 according to the present embodiment provide the following effect.

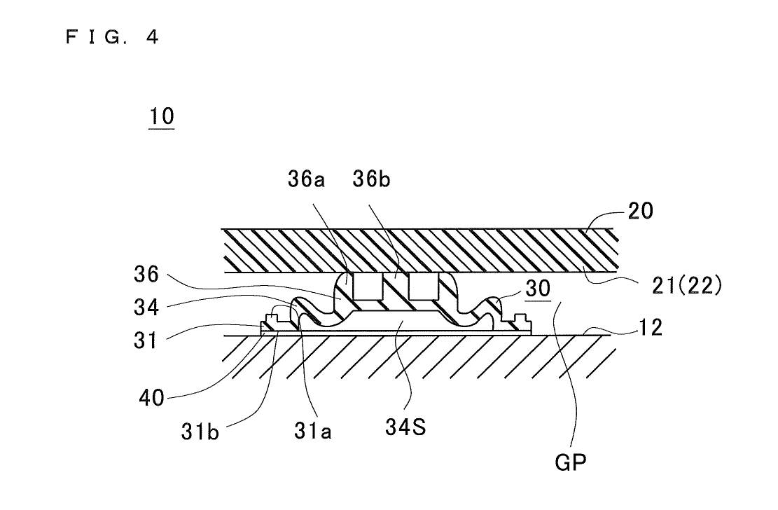

(1) FIG. 4 is a cross-sectional view of the buffer member 30 in the case where an impact is given to the casing 20 when the hard disk drive apparatus 10 has dropped or fallen over, for example. A displacement occurring in the casing 20 owing to the impact given to the casing 20 is conducted to the buffer member 30. The buffer member 30 is compressed with the dome section 34 being flexed between the supporting section 31 and the abutment part 36. At this time, since the sealing chamber S34, which has airtightness, functions as an air damper, the impact can be cushioned.

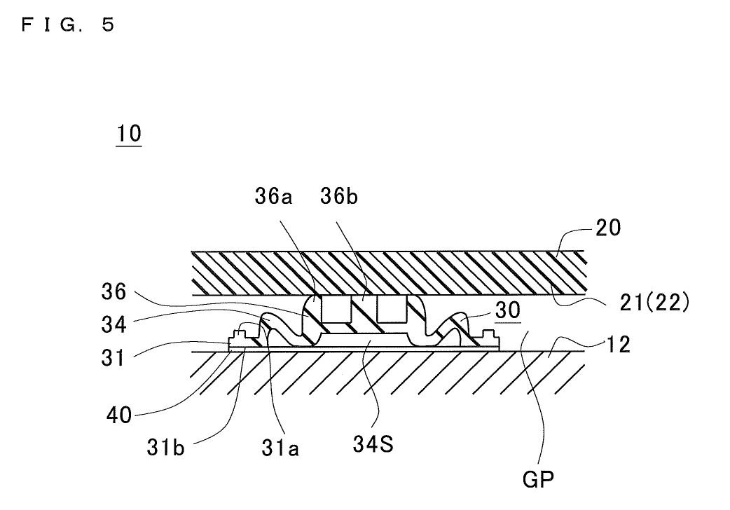

(2) FIG. 5 is a cross-sectional view of the buffer member 30 in the case where a larger impact than that in the case shown FIG. 4 is given to the casing 20. The abutment part 36 is configured to have a larger stiffness than that of the dome section 34. Therefore, when the buffer member 30 has been compressed, the abutment part 36 keeps its shape while its lower end comes into contact with the wall surface of the hard-disk drive unit 12, and the dome section 34 is preferentially distorted into a shape having an M-shaped cross-sectional surface. At this time, the buffer member 30 does not lose the space of the sealing chamber 34S in the dome section 34 even when the buffer member 30 has received a large compression force. Therefore, so-called bottom hitting in which the hard-disk drive unit 12 and the casing main body 21 directly collide with each other does not occur, and the impact force does not rapidly increase.

(3) As shown in FIG. 2 and FIG. 3, even if the dimension tolerance of the clearance between the hard-disk drive unit 12 and the casing 20 is large or the buffer member 30 is to be applied to hard-disk drive units having different outer dimensions, since the dome section 34 has a flexibility, the buffer member 30 can absorb such differences in dimension, and can be attached in the gap such that the buffer member 30 can exert its buffer effect sufficiently. In addition, by such a configuration, the buffer member 30 can be applied also to a large clearance without greatly increasing the amount of material. Therefore, cost reduction can be realized and the general versatility can be increased.

(4) The adhesive sheet 40 makes the airtightness of the sealing chamber 34S higher, thereby enhancing the function of the sealing chamber 34S as an air damper.

(5) The projecting rail 31a protruding at the outer peripheral portion of the supporting section 31 enhances a mechanical strength of the peripheral portion of the supporting section 31, thereby preventing the edge portion of the supporting section 31 from peeling, and maintaining the airtightness of the sealing chamber 34S.

It is noted that the present invention is not limited to the above embodiment. The present invention may be implemented in various embodiments without departing from the scope of the invention. For example, the following modifications may be conducted.

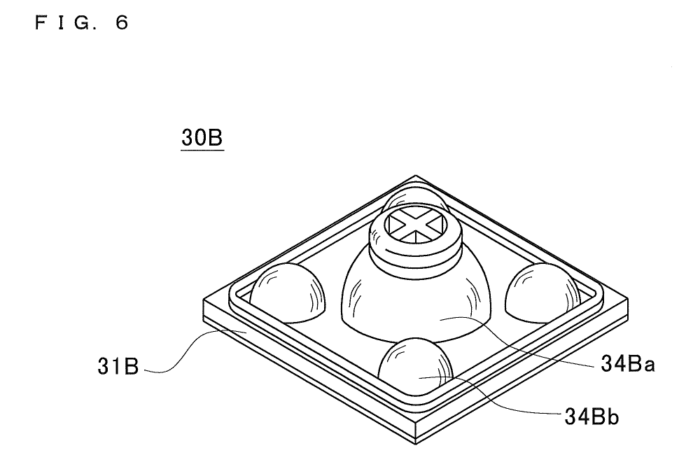

FIG. 6 to FIG. 8 are perspective views of buffer members according to modifications of the present invention. A buffer member 30B shown in FIG. 6, includes sub dome sections 34Bb. The sub dome sections 34Bb are arranged around the outer periphery of a dome section 34Ba and at the corners of a supporting section 31B. The heights of the sub dome sections 34Bb are smaller than that of the dome section 34Ba. In addition, the space in each of the sub dome sections 34Bb forms a sealing chamber 34BbS, which is subjected to elastic deformation owing to a stress. The sub dome sections 34Bb having the above configurations are compressed after the dome section 34Ba is sufficiently compressed, thereby reducing the impact force. Also, the sub dome sections 34Bb function as backups when the dome section 34Ba loses its airtightness owing to damage or the like. In addition, the number of the sub dome sections 34Bb is not limited to four, and any number of the sub dome sections 34Bb may be used.

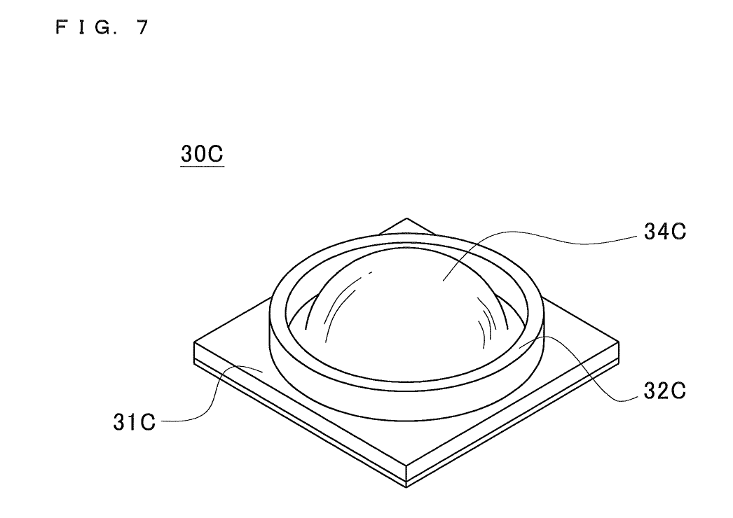

A buffer member 30C shown in FIG. 7 includes a projecting rail 32C at the outer peripheral portion of a dome section 34C. That is, the projecting rail 32C is formed in a cylindrical shape along the whole periphery of the dome section 34C. The height of the projecting rail 32C is smaller than that of the dome section 34. The projecting rail 32C is subjected to a compression force after the dome section 34C is compressed, thereby assisting the dome section 34C and reducing the impact force. Also, the projecting rail 32C functions as a backup when the dome section 34C loses its airtightness owing to damage or the like.

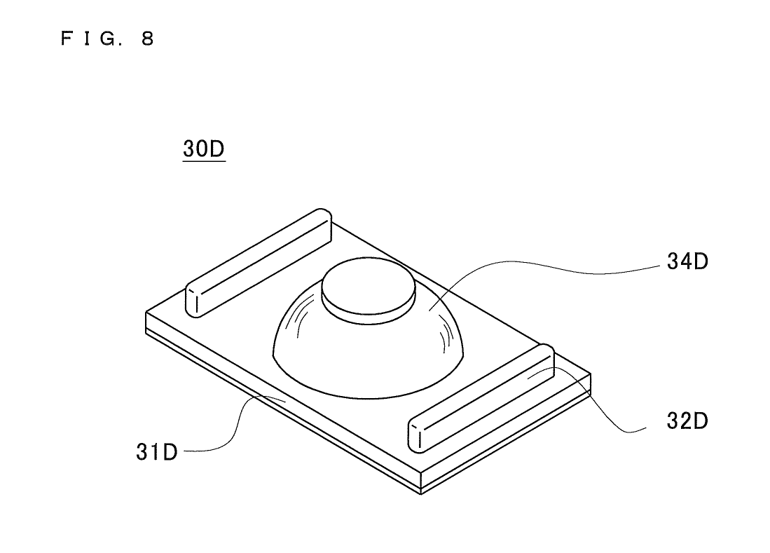

A buffer member 30D shown in FIG. 8 includes projecting rails 32D, having a linear shape, that are lateral to a dome section 34D and along the both short sides of a supporting section 31D. The projecting rails 32D provide the same effect as the projecting rail 32C of the buffer member 30C.

In addition, the buffer member according to the present invention may be configured by a combination of components of the buffer members described above, for example, a combination of the abutment part, the projection rail, the sub dome section, and the like, as appropriate.

In addition, although in the present embodiment, the buffer members 30 are adhered to the outer wall surface of the hard-disk drive unit 12, the present invention is not limited thereto, and the buffer members 30 may be adhered to the inner wall surface of the casing 20. In addition, although the adhesive sheets 40 are used as means for attaching the buffer members 30, the buffer members 30 only need to be placed, with their position being fixed, between the hard-disk drive unit 12 and the casing 20. Therefore, instead of using the adhesive sheet 40, an adhesion agent may be directly applied to the supporting surface 31b of the supporting section 31.

In addition, although the storage apparatus of the present embodiment is a hard disk drive apparatus having a 3.5-inch disk, the present invention is applicable to various apparatuses such as a portable hard disk drive apparatus, a hard disk drive apparatus stored in a computer, and an optical storage apparatus such as a DVD (registered trademark) drive apparatus or a Blu-ray (registered trademark) disk drive apparatus.

What is claimed is:

1. A storage apparatus comprising:
a casing forming a housing chamber;
a disk drive housed in, at a spacing from, the housing chamber, such that unit outer walls of the disk drive are separated by a clearance from inner walls of the casing; and
a buffer member interposed in the clearance between the disk drive and the casing, for absorbing an impact stress; wherein
the buffer member
is formed of a material having flexibility, and
is provided with
a support part fitted to a wall surface of one of either the disk drive or the casing,
a hemispherically shaped dome part, formed on the support part, and
an abutment part, formed along a top portion of the dome part, abutting on a wall surface of the other of either the disk drive or the casing; and
the dome part and the support part form, together with the wall surface of the one of either the disk drive or the casing, a sealing chamber sealing in air, whereby the dome part is lent elasticity.

2. The storage apparatus according to claim 1, further comprising an adhesive sheet, fastened to the support part, for enhancing airtightness of the sealing chamber.

3. The storage apparatus according to claim 1, wherein against a direction in which the dome part flexes, the abutment part is of stiffness that is greater than that of the dome part.

4. The storage apparatus according to claim 1, wherein the support part on a peripheral portion thereof includes a projecting rail.

5. The storage apparatus according to claim 1, wherein:
at least one sub-dome part whose height is lower than that of the dome part is formed on a peripheral portion of the support part that is along an outer side of the dome part; and
the at least one sub-dome part forms, with the wall surface of the one of either the disk drive or the casing, a sealing chamber for sealing in air, whereby the at least one sub-dome part is lent elasticity.
